(19) United States
(12) Patent Application Publication
(10) Pub. No.: US 2002/0169632 A1
(43) Pub. Date: Nov. 14, 2002

(54) Archival storage and access to information via the internet

(76) Inventor: James Grossman, Westport, CT (US)

Correspondence Address: CANTOR COLBURN LLP, 55 Griffin Road South, Bloomfield, CT, 06002, US

(21) Appl. No.: 10/138,236

(22) Filed: May 3, 2002

Related U.S. Application Data
(60) Provisional application No. 60/289,898, filed on May 9, 2001.

(51) Int. Cl. H04L 9/32; G06F 17/60

(52) U.S. Cl. 705/1; 713/193

(57) ABSTRACT

A system and method for recording information from a subscriber. The system provides a record that is an impartial third party verification of thoughts, ideas and other material, that is also universally accessible to all. The system provides a website giving people a centralized location to take a position on a thought or idea, and to validate that position with a date certain, time certain and document number. The person then may have the option to further memorialize their record in a variety of ways via promotional merchandise associated through the website.

### CROSS-REFERENCE TO RELATED APPLICATIONS

This application claims the benefit of U.S. provisional application serial No. 60/289,898 filed May 9, 2001, the entire contents of which are incorporated herein by reference.

### FIELD OF THE INVENTION

The invention relates to a method and apparatus for the archival storage and recovery of data received via the Internet from any number of unrelated or independent sources.

### BACKGROUND OF THE INVENTION

The Internet provides access to vast archival repositories of information, including that gathered by institutions, businesses and commercial databases. Much of the stored information is available without charge. Commercial databases charge subscribers based upon the nature and volume of the information searched and/or retrieved.

Websites on the Internet are maintained by individuals that publish information that can be inspected by anyone who visits the site. However, the time and expense associated with establishing and maintaining a website exceeds many individuals' capabilities.

Individuals who wish to express their viewpoints on topics of interest can visit chatrooms established for this purpose. However, any opinions or predictions entered in this type of Internet forum is deemed to be transitory, and if retrievable at all, the criteria are arbitrary, controlled by the chatroom's sponsor and will vary among sponsors.

Individuals who wish to create an electronic archival record for a definite, or indefinite period of time that can be deposited and retrieved via the Internet presently have no service available to them.

### SUMMARY OF THE INVENTION

Embodiments of the invention include a system and method for recording information from a subscriber. The system provides a record that is an impartial third party verification of thoughts, ideas and other material, that is also universally accessible to all. The system provides a website giving people a centralized location to take a position on a thought or idea, and to validate that position with a date certain, time certain and document number. The person then may have the option to further memorialize their record in a variety of ways via promotional merchandise associated through the website.

### BRIEF DESCRIPTION OF THE DRAWINGS

FIG. 1 is a block diagram of an exemplary system in an embodiment of the invention.

### DETAIL DESCRIPTION OF THE INVENTION

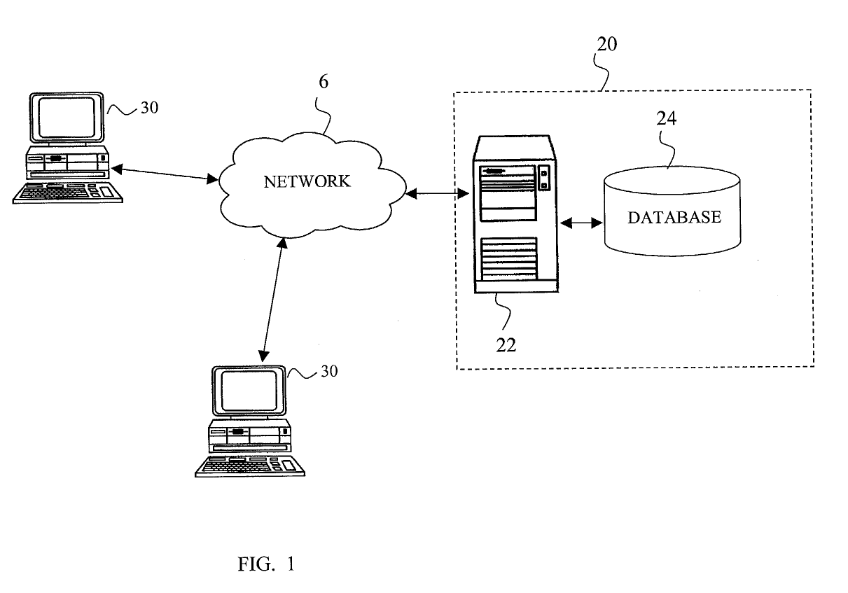

FIG. 1 is a block diagram of an exemplary system for archiving information in an embodiment of the invention. The system includes an archival storage system 20 including a server 22 and a database 24. Server 22 contains content (e.g., HTML files) defining a website, referred to herein as GoOnRecord.com. The database 24 contains archival data or records submitted by subscribers to the system. The database 24 may be part of server 22 or a separate physical device accessible by server 22. The server 22 may be implemented using commercially available servers executing a computer program to implement the processes described herein. The server 22 acts as a database server to store and retrieve archival data in database 24. The server 22 also acts as a network server to interact with remote terminals 30.

Archival storage system 20 is coupled remote terminals 30 by a network 6. The network 6 may be any type of known network including a wide area network (WAN), secure network (e.g., extranet, virtual private network), global network (e.g., Internet), etc. One or both of the remote terminals 30 and the archival storage system 20 may be connected to the network 6 in a wireless fashion. In a preferred embodiment, the network 6 is the Internet.

The remote terminal 30 may be used to submit archival data or view archival data via archival storage system 20. The remote terminal 30 may be implemented using a general-purpose computer executing a computer program for carrying out the processes described herein. In a preferred embodiment, the remote terminal 30 executes a user interface application (e.g., web browser) to interface with archival storage system 20 over network 6. The remote terminal 30 may be connected to network 6 in a wireless fashion and may be any type of web-enabled device such as a laptop, PDA, cell phone, etc.

When a person accesses server 22 from remote terminal 30, they access a main page that provides options to view existing records or to create new records. Access to the website to view or record records may also involve less traditional options such as remote video and audio sites that would allow people to go on record. Records may consist of typed entries, graphics, voice recordings, linked transactions, or any other possibility that technology allows.

For new subscribers, the server 22 receives and records personal identifying data from each of the plurality of subscribers in a subscriber file in database 24. The subscriber is assigned a unique account identifier and general access code. A subscriber at remote terminal 30 may then submit information for archival recordation on database 24 in an inalterable form (e.g., read only) in association with the subscriber's account number. The date and time of the record is also stored in database 24 along with the record. Server 22 assigns a unique record identification code to each of a plurality of separate archival data entries recorded in association with an individual subscriber's account.

Subsequently, any other user at a remote terminal 30 may access the server 22 and retrieve records on database 24. To retrieve records, a user at terminal 30 submits a subscriber's account identifier (or other identifier such as subscriber name) and general access code. The user may obtain the general access code from the subscriber. Once verified, a user can view records archived by the subscriber associated with the account F identifier.

In an alternate embodiment, a subscriber may also designate a limited access code. Upon submitting information for archival recordation, the subscriber can associate the record with either a general access code or a limited access code. The subscriber can then limit access to certain records by associating the record with the limited access code. A subscriber may keep the limited access code secret thereby only allowing viewing of the record when the subscriber is present at terminal 30 to enter his/her limited access code.

The provider of the archival storage system 20 may generate revenue in a number of ways. First, a billing record may be created in association with the subscriber's account identifier at the time of the recording of archival data. Thus, a subscriber is charged to record information. Second, a billing record may be created in association with the subscriber's account identifier at the time of the retrieval for display of the record. Thus, the subscriber is charged when a record is viewed.

The subscriber can control publication of his/her records though multiple methods. The subscriber may assign a termination date for a record when the archival data is entered in the database 24. Retrieval for display of the recorded archival data is discontinued after the termination date. Alternatively, a subscriber may assign a publication date for the archival data, whereby retrieval of the data for display can only occur after the publication date in response to an inquiry that is received from a remote terminal.

The record may also be encrypted in accordance with an encoded encryption program at the time of its entry in the database 24. The encryption program code (e.g., a key) is associated with the stored archival data and the encryption program code may be displayed to the subscriber. The encryption program code may be recorded in association with the subscriber's account identifier. In one embodiment, the subscriber's general access code corresponds to the encryption program code used to decrypt the record.

Records for one subscriber may be linked in database 24. In this way, a user at terminal 30 may locate and view multiple records for the same subscriber. Alternatively, records for two or more subscribers may be linked so that, for example, contravening views on a topic may be contrasted. The records from a subsequent subscriber may be records in association with a previously recorded archival data entry associated with a different subscriber's account.

The records on database 24 may be organized in a variety of manners. In one embodiment, the archival data record includes a category identifier. The category identifier is included in a listing of subject matter identifiers maintained in database 24. A user at terminal 30 may retrieve archival data for display at the remote terminal 30 by submitting one or more of a subscriber's name, a category identifier and a search word or words. Records may be retrieved by category, individual name, document number or date/time of record. Other categories or options may be added.

Category possibilities include sports, entertainment, business, science, politics, arts, etc. There may also be options to choose further sub-categories. Once the subscriber has chosen a category and/or subcategory, they would then record the entry by typing, scanning, voice recordings, etc. The person will choose an initial time frame of how long they want to keep the record logged and may choose to encrypt the record, to limit the number of viewers, or allow full/partial public access. All options may be associated with a time frame limiting or allowing access. When complete, the entry would be recorded and logged with a date, time and document reference identification.

Any entries can be customized to any characteristics the creator of the record chooses. He could have his choice of fonts, his own handwriting, backgrounds, artwork, music, animation or any other available mechanisms to personalize the record for those who see it.

The document can then be accessed at any time by anyone with means to access the website, unless the person who recorded the entry has limited the access of others to the file, or has encrypted the file. The author of the entry can alter the viewing options at any time, but may not alter the entry. There may be options to amend the entry by associating corresponding document numbers to the original file, but each entry remains itself un-altered until cancelled or removed from the website. It is up to the creator of the entry to decide how long the entry will exist, whether it is an hour or forever, and anything in between. The document may be added to by the original author or by others if the original author permits. These documents would be linked by codes or other corresponding associations.

The server 22 may also provide a search engine. A user may have options to choose to see a single original file, or the original file and all of the amendments, or they may choose to see solely the amendments themselves or other such variations. They may pull up records by topics, categories, key words and phrases or any such typical search engine methods.

Once assigned a document number, the records can then be sent at any time either by themselves or in conjunction with other records to others via e-mail, fax or other delivery method. A person may choose to send a personal message with the record as it is sent. The records may also be memorialized by plaques, certified documents, books, t-shirts or other such promotional merchandise offered through the website. The website may offer volumes of archived records, books or other compilations of records from the site. The accumulation of this data may be used in various forms by the website. It may also employ contests such as random selections for free records, prizes for predictions, specials such as “The best of the Day, Week, Month or Year” or other marketing promotions to drive traffic to the website and encourage visitors.

The personal identifying data may be more stringent. For example, the personal identifying data associated with subscribers may include birth date, Social Security number, familial relationships, finger print, eye scans, hand written signatures, and combinations thereof. These may be used to determine different categories of entry and limited access, or to distinguish priority of services.

Billing and fees are established at the initial sign-in on the main page. Some billing options may be to pay after a record exceeds a certain many characters, pay after each transaction, weekly, monthly or yearly payments etc. A customer may have the option to change billing arrangements.

There would be offered a variety of ways to acquire time as well. For example, sponsors, family rates, earning points, buy one/get one, gift certificates etc. Or in some instances, the creator of the entry may be paid for his feedback or receive incentives by the website or companies who run special promotions.

This website makes sense because it is human nature to speculate about the future or argue a position. These ideas and opinions are what make the individual. These, however, are often fleeting moments that are lost with time. In the same way that people have scrapbooks of pictures and mementos to recollect memories, this website can record viewpoints and dreams to share with others or to pass on to children, grandchildren and friends. For example, someone may want to have a record of all the best moments of a friendship and send it to that friend for a momentous occasion. It is possible that as a person gets older, they would want to have a record of the viewpoints and dreams they have over the years, to memorialize for years to come and to prove their loyalties and to ensure they don't forget where they once stood on important issues. Or a person could use the website as a diary only the author can read.

As another similar example, at the birth a child some parents may want to record their excitement or their hopes and dreams for the future to share with that child at a later age. They may have the ability to scan in documents and pictures to make an on-going scrap book. They could have yearly albums that show the family as time passes. This could also serve as a record for towns or any other organized group.

Every year millions of people resolve to change for the better in the form of New Year's Resolutions which are quickly forgotten and left behind. Similar promises are made on Birthdays or after life-changing events. Lists such as these, that people repeatedly make and forget, can be recorded so that a person can look back and see how far they have come, or locate a pattern of behavior that otherwise may have passed unnoticed. GoOnRecord.com can serve as a time capsule of personal thoughts and ideas that can be “buried” for a predetermined period of time. The person who creates the document can control via encryption or limited access when it is recovered.

The website could be used by writers, journalists or just the average person who wants to record an ongoing record of a big event in life. If, for example a student wants to have a central spot to record his thoughts and experiences on a trip abroad, he could use a specific identification number to log all of his entries for that trip. Friends and relatives could log onto the website to read everyday about his experiences and he wouldn't have to e-mail every single one of them every day. They could simply pull up his identification number on the website and they would be able to read about his trip or see photographic or other attached materials. In this way it works like an e-mail in reverse. If he wanted to keep some privacy and have only certain records available to certain people, he could have them only accessible to the people of his choosing by coding specific parts for specific people.

This works the same for personal documents such as Wills, Deeds, insurance records, diaries and any other recordable documentation. Privacy levels can be adjusted to allow as much access or privacy as desired. If necessary, the website can serve as a safe and secure place for records. Furthermore, it has the added security of being part of a centralized protected database which minimizes risk of lost or misplaced information.

GoOnRecord.com may also be used as a second bank account. A subscriber could record bank statements independent of the banks records in the event that there is a discrepancy between the subscriber's records and the bank records.

In arguments people are always anxious to express their opinions in a way to be certain they are heard. It can be difficult to get a point across when it is an emotional issue, or if there is a lot at stake. There are misinterpretations of what was said. Sometimes one person isn't really listening or can't see the other's point of view. If there were someplace central and accessible to all, where people could go to record the thought of the moment, or their side of the argument, they could go back to it and have a reference point to view things in a different light or to prove the position. The website would function as a vehicle that allows time to be the judge.

GoOnRecord.com would serve as a third impartial party that records positions before conflict resolution. The people involved can then go in after the fact and see where each other really stood at the time of the conflict. By recording their opinions on a centralized website, they can later be instantly verified. Imagine if you had predicted hoola-hoops would be big, Woodstock would be an event, the Berlin Wall would fall, they would put a man on the moon. Imagine if you saw a movie like Casablanca the first time it was released. All of the critics give it poor reviews, but you go on permanent record saying it will be remembered as one of the greatest classics of all time. Many years later, you can look back and see who was right.

A politician takes a stand that we will be sending people to live on Mars by 2010. Any person who wants to can go on record agreeing or disagreeing. Millions of people could add to the politician's original record and in 2010 it would be public record which prediction stands the test of time.

Third party verification can be related to phone conversations, for example. If a group is having a conference call that they wish to memorialize, they may access the website via technology that links the phones involved to the website so that the conference is recorded. The conference could be recorded in writing or in voice recordings, video or any other or a combination of methods. This idea could be further expanded to include stenographers in legal matters or any other experience that mandates third party verification.

The uses of GoOnRecord.com can expand into the professional world as well as the personal. For example, if a new graduate is trying to break into the fashion industry, he may want to add credibility to his resume by showing how consistently every year he has predicted the trends accurately. Or a scientist may want to be able to prove that the data he collected was monitored on a regular basis over a period of years. An employee in a very competitive working environment may want to anticipate the next move of the competition and be able to present that to his supervisor to help advance his position with the company. A student, journalist or author may want to use the website for research on public opinion or for such things as history and social patterns.

Also, it is a popular pastime for people to discuss political issues or current hot news topics in newspapers or at parties and among friends. Editorials are written to speak out against issues that people feel strongly about. Sometimes people just want to feel that their voice is heard and speak their mind. If there were a centralized place where people could go to log their opinion, not only would they have their say, but the information could be used by organizations, pollsters, politicians and the media for material or to judge the temperature of the public. People could write their thoughts and opinions and have it validated by being on the record and let others know where they stand. Editorials could be recorded for every article ever written and would be accessible to millions.

In the past, your thoughts and opinions reached only a few people, were soon forgotten, didn't matter to many, were misplaced, thrown out, didn't change anything, weren't published. With GoOnRecord.com they will have the potential to be read by many others if not millions, can be remembered forever, wont be misplaced or thrown out, have more power to change things will be published. Furthermore they will be justified or proven otherwise by time. You can have your voice recorded on any virtually any topic at anytime you choose for as long as you want.

This website serves as a mechanism that allows a person to instantly save something forever if they wish. It is the ultimate “I told you so,” location and serves as a place to challenge others to go on record. Your opinion on virtually any topic that is important to you now has a place where you can give it world-wide expression and have it accessible to millions. For the first time, not only is there free speech, but an equal opportunity to be heard. You can say anything about anything and you can record it forever.

There has always been a value to see things as they are and to compare that to what they become. This website would now allow an organized place to record it for anyone to see. In this way, this website provides a unique method to memorialize a history.

A case in point that illustrates the practical and common need for a website such as GoOnRecord.com can be seen in an argument between two of the world's most renowned physicists, Stephen Hawking and Keith Thorne. On a PBS series regarding time travel, these physicists were arguing over the concept of anti-matter and its involvement in the process of time travel. Years ago they had placed a bet with each other over who had the right theory. They had written their conflicting viewpoints on a board so that when the true theory would be proven correct, they would have a record of who was right. They wanted to have a document to look back on that would settle the argument. If GoOnRecord.com had been available to record their viewpoints, not only could they have kept track of their bet, but there would be a public ally accessible record that others could see as well. Instead of being limited to a brief camera shot of the document, people who were interested could access the record and read the theories in full for themselves, and even have the opportunity to add their own comments. Employing the method of the invention, GoOnRecord.com opens up a whole new arena of insight and educational opportunities not previously available.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

I claim:

1. A method of providing archival record storage and retrieval to a plurality of unrelated individual subscribers via the Internet, the method comprising:
providing an interactive Internet website responsive to data received from remote terminals of a plurality of subscribers;
providing data storage means in association with said website;
receiving and recording personal identifying data from each of the plurality of subscribers in a subscriber database;
assigning a unique account identifier and general access code to each subscriber;
retrievably recording archival data received from a subscriber in an inalterable form in the data storage means in association with the subscriber's account number;
thereafter retrieving archival data from the data storage means for display of the data at a remote terminal in response to an inquiry from the remote terminal accompanied by a subscriber's account identifier and general access code.

2. The method of claim 1 which further comprises recording the date of the recording of the archival data in the data storage means.

3. The method of claim 1 where the archival data is recorded in ROM data storage means.

4. The method of claim 1 which further comprises assigning a unique record identification code to each of a plurality of separate archival data entries recorded in association with an individual subscriber's account.

5. The method of claim 4 which further comprises the steps of assigning each subscriber a unique limited access code and thereafter retrieving archival data from the data storage means for display of the data at a remote terminal in response to an inquiry from the remote terminal accompanied by a subscriber's account identifier and limited access code.

6. The method of claim 5 which further comprises retrieval for display of the archival data in response to the entry of the record identification code assigned to the data entry.

7. The method of claim 1 which comprises the further step of creating a billing record in association with the subscriber's account identifier at the time of the recordal of archival data.

8. The method of claim 5 which comprises the further step of creating a billing record in association with the subscriber's account identifier at the time of the retrieval for display of the data entry.

9. The method of claim 1 which further comprises assigning a termination date for the archival data when the archival data is entered in the data storage means, whereby retrieval for display of the recorded archival data is discontinued after the termination date.

10. The method of claim 9 which further comprises assigning a publication date for the archival data, whereby retrieval of the data for display of the recorded archival data occurs after the publication date in response to an inquiry that is received from a remote terminal accompanied by the subscriber's name.

11. The method of claim 1 which comprises the further steps of:
encrypting the archival data in accordance with an encoded encryption program at the time of its entry in the data storage means;
associating the encryption program code with the stored archival data; and displaying the encryption program code to the subscriber.

12. The method of claim 11 which further includes recording the encryption program code in association with the subscriber's account identifier.

13. The method of claim 11 in which the subscriber's general access code corresponds to the encryption program code.

14. The method of claim 1 where the archival data is selected from the group consisting of text, audio, still images, virtual video images, and combinations thereof.

15. The method of claim 4 which includes the further step of linking two or more of the plurality of archival record entries for one subscriber.

16. The method of claim 4 which includes the further step of linking one or more entries of two or more subscribers.

17. The method of claim 10 which comprises the further steps of recording archival data from a subsequent subscriber in association with a previously recorded archival data entry associated with a different subscriber's account.

18. The method of claim 2 which comprises the further steps of producing a tangible copy of the archival copy retrieved in response to a request from the remote terminal.

19. The method of claim 1 where the archival data record includes a subject matter identifier and the subject matter identifier is included in a listing of subject matter identifiers accessible at the interactive website.

20. The method of claim 19 which comprises the further steps of retrieving archival data for display at a remote terminal in response to an inquiry from the remote terminal accompanied by information selected from the group consisting of a subscriber's name, a subject matter identifier, a search word or words, and combinations thereof.

21. A method of providing an electronic safe deposit box via the Internet, the method comprising:
providing an interactive Internet website responsive to data received from remote terminals of plurality of subscribers;
providing data storage means in association with said website;
receiving and recording legally cognizable personal identification data from each of the plurality of subscribers;
assigning a unique account identifier and general access code to each subscriber;
retrievably recording archival data received from a subscriber in an inalterable form in the data storage means in association with the subscriber's account number;
thereafter retrieving archival data from the data storage means for display of the data at a remote terminal in response to an inquiry from the remote terminal accompanied by a subscriber's account identifier and general access code.

22. The method of claim 21 where the legally cognizable personal identification data is selected from the group consisting of birth date, Social Security number, familial relationships, finger print, eye scans, hand written signatures, and combinations thereof.
